(19) United States
(12) Patent Application Publication
(10) Pub. No.: US 2009/0168746 A1
(43) Pub. Date: Jul. 2, 2009

(54) INCREASE EFFECTIVE BEACON CAPACITY

(76) Inventors: Alaa Muqattash, San Diego, CA (US); Ghobad Heidari-Bateni, San Diego, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/968,597

(22) Filed: Jan. 2, 2008

(51) Int. Cl. H04J 3/06

(52) U.S. Cl. 370/350

(57) ABSTRACT

According to an embodiment of the invention, systems and methods are provided to allow wireless network devices to transmit more data than the maximum length beacon during a beacon period. In some embodiments, the method includes transmitting an original beacon, determining if a beacon slot is available, selecting the available beacon slot; determining if the selected slot is within a beacon period of a neighbor, and transmitting an additional beacon. Other embodiments may include determining a different device address and EUI48 and selecting a new MAC information element for the additional beacon.

### TECHNICAL FIELD

The present invention relates to communications, and more particularly, some embodiments relate to communications methods and systems that include beacon transmissions.

### DESCRIPTION OF THE RELATED ART

With the many continued advancements in communications technology, more and more devices are being introduced in both the consumer and commercial sectors with advanced communications capabilities. Additionally, advances in processing power and low-power consumption technologies, as well as advances in data coding techniques have led to the proliferation of wired and wireless communications capabilities on a more widespread basis.

For example, communication networks, both wired and wireless, are now commonplace in many home and office environments. Such networks allow various heretofore independent devices to share data and other information to enhance productivity or simply to improve their convenience to the user. One such communication network that is gaining widespread popularity is an exemplary implementation of a wireless network such as that specified by the WiMedia-MBOA (Multiband OFDM Alliance). Other exemplary networks include the Bluetooth® communications network and various IEEE standards-based networks such as 802.11 and 802.16 communications networks, to name a few.

In the WiMedia-MBOA standard, the bandwidth is divided into superframes, which in turn are divided into time slots for the transmission and reception of data by the various electronic devices associated with the network. Some communication networks are divided into periods or frames that can be used for communication and other activities. For example, some networks have a scheduling window such as, a beacon period, for scheduling upcoming communication activities.

During this beacon period a WiMedia-MBOA device(s) may transmit a beacon frame. A beacon frame is the format of information transmitted during a beacon period. Using a beacon frame allows a wireless device to maintain synchronization with other wireless devices in a wireless network. In one example system, a beacon frame may include a header that contains routing information for the frame; beacon parameters, that indicate signaling methods; and one or more information elements.

In the WiMedia Media Access Control Layer (“MAC”), the maximum length beacon frame has a frame payload of 320 octets. The frame payload does not contain the Frame Check Sequence (“FCS”). In some scenarios, however, this maximum length is not enough for a device to include all the information elements it wishes to include. For example, in some cases an application may include a large amount of information in beacons in the form of Application Specific information elements (“ASIE”). An ASIE is similar to the Traffic Indication Map (“TIM”) Information Element. It may be implemented to contain the device address or other identification of every neighboring device for which WiNET traffic is buffered.

Using an ASIE to send information may, in many cases, be more efficient then sending the information by other means. For example, sending that same application information outside the beacon period, e.g., via Priority Channel Access (“PCA”) or Distributed Reservation Protocol (“DRP”) requires the device to do a lot more processing than sending such information in beacons. Accordingly, it may be beneficial and perhaps necessary in some cases to transmit more data than the maximum length beacon during a beacon period.

For example, in some cases a device might include in its beacons several different information elements that may be required by the WiMedia Media Access Control Layer layer. A device that has 50 neighbors, 4 DRP information elements (each with 2 DRP allocations), and is acting as a hibernation anchor for its neighbors is required by the WiMedia Media Access Control Layer specification to send at least 330 bytes of information in its beacons. Such a device cannot fit that much information in one beacon, and so it might be considered incompliant to the specification, or it has to drop some of its functionalities, e.g., hibernation anchor, unless it has a different method to send its information elements.

### BRIEF SUMMARY OF EMBODIMENTS OF THE INVENTION

According to various embodiments, a receiver may include information elements in its beacon. The beacon may be, for example, in a superframe. For example, according to the WiMedia Media Access Control Layer specification, a device transmits a beacon during the beacon period of every superframe. The beacon that a device transmits during the beacon period of every superframe will be referred to as the “original” beacon.

According to various embodiments, a device may be allowed to send one or more additional beacons, e.g., in addition to its original beacon, during a beacon period. For example, a device might be allowed to send one or more additional beacons in any available beacon slots. In the additional beacon(s), the device may include some or all information elements that could not fit in its original beacon.

According to some embodiments, a device may be allowed to send one or more additional beacons, e.g., in addition to its original beacon and still be backward compatible. For example, to allow for this behavior and still be backward compatible with MAC 1.0 devices, a device might include one or more modifications.

According to some embodiments, a device may use a different device address (“DevAddr”) and 48-bit extended unique identifier (“EUI48”) in the media access control layer (“MAC”) header and Beacon Parameters field, respectively, of any additional beacons, e.g., any beacons that are not an original beacon. In this way a MAC 1.0 device, which does not implement the systems and methods described herein builds a table in its internal space that maps every 48-bit extended unique identifier to a device address that uses its received beacons. If the additional beacon uses the same 48-bit extended unique identifier or the same device address, then depending on how the MAC 1.0 device has been implemented, this might cause a few misbehaviors in constructing the table mentioned above.

According to some embodiments, a new Media Access Control Layer Information Element is created from the reserved range of Information Element ID numbers in MAC 1.0. The new Information Element may include the original beacon's 48-bit extended unique identifier. This may allow a device that implemented the extension proposed in this work, e.g., MAC 2.0, to understand that the information contained in an additional beacon belongs to a device that sent or will send (in the case the additional beacon is sent in an earlier slot) an original beacon in the same superframe. According to some embodiments, the new Media Access Control Layer Information Element might include an element ID field, a length field, an 48-bit extended unique identifier of the original beacon field and various lEs (1 . . . k).

Devices that implemented the systems and methods described herein, e.g., MAC 2.0, will generally be able to understand information contained in any additional beacons while devices that do not implement these systems and methods may not always be able to understand the information contained in an additional beacon. This additional information is transmitted by, for example, a MAC 2.0 device that has sent (or will send) an original beacon in the same superframe. Accordingly, in some embodiments, an additional beacon may contain only new information elements not defined in MAC 1.0. The Application Specific information elements may also be limited to new Application Specific information elements not defined in MAC 1.0.

The systems and methods described herein may also be useful for dealing with a mix of MAC 1.0 and MAC 2.0 neighbors. For example, when information elements using the MAC 1.0 standard cannot fit in one beacon payload any MAC 2.0 devices might use the systems and methods described herein. According to some embodiments, a device might be required to send more information elements than can be accommodated in one beacon In some cases, a MAC 1.0 device might be designed to alternate between various lEs from one superframe to the next. In this way a MAC 1.0 device might avoid exceeding the maximum beacon length. The device, however, will not get Using the proposed method in this work, a MAC 2.0 device can include in the additional beacon all information elements that were not included in the original beacon in the same superframe. Such approach, although not useful for neighbors that are MAC 1.0, is very useful for all neighbors that are MAC 2.0 since such neighbors will have a more up-to-date version of each others' information elements.

In addition to WiMedia-MBOA (Multiband OFDM Alliance based wireless networking standards, the proposed mechanism for enables the device to transmit more data than the maximum length beacon during a beacon period may be extended to other wireless systems. For example, as discussed above, other exemplary networks include the Bluetooth© communications network and various IEEE standards-based networks such as 802.11 and 802.16 communications networks. Other networks might also to name a few.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a block diagram illustrating one possible configuration of a wireless network that can serve as an example environment in which the present invention can be implemented.

FIG. 2 is a diagram illustrating bandwidth that can be divided into superframes, which in turn can be divided into time slots.

FIG. 3 is a diagram illustrating one example beacon frame in accordance with one embodiment of the systems and methods described herein.

FIG. 4 is a flowchart illustrating one example method in accordance with one embodiment of the systems and methods described herein.

FIG. 5 is a flowchart illustrating one example method in accordance with one embodiment of the systems and methods described herein.

The figures are not intended to be exhaustive or to limit the invention to the precise form disclosed. It should be understood that the invention can be practiced with modification and alteration, and that the invention be limited only by the claims and the equivalents of.

### DETAILED DESCRIPTION OF THE EMBODIMENTS OF THE INVENTION

According to various embodiments, a receiver may include information elements in its beacon. The information elements can then be used to send feedback information about packets received during the previous superframe(s). This feedback information may contain some acknowledgement information, e.g., for packets received for a specific data stream that have the ACK policy set to No-ACK. For example, the feedback information may include information elements that include acknowledgement information that acknowledge the reception of previously transmitted packets, e.g., packet error rates, bit error rates, signal-to-noise ratio, or other measures of signal quality might, for example, be included in the Information Element for transmission has part of the beacon.

Before describing the invention in detail, it is useful to describe an example environment in which the invention can be implemented. One such example is a wireless beaconing network in which multiple electronic devices (for example, computers and computing devices, cellular telephones, personal digital assistants, motion and still cameras, among others) can communicate and share data, content and other information with one another. One example of such a network is that specified by the WiMedia standard (within WiMedia and Multi-Band OFDM Alliance). From time-to-time, the present invention is described herein in terms of a distributed network or in terms of a WiMedia standard. Description in terms of these environments is provided to allow the various features and embodiments of the invention to be portrayed in the context of an exemplary application. After reading this description, it will become apparent to one of ordinary skill in the art how the invention can be implemented in different and alternative environments. Indeed, applicability of the invention is not limited to a distributed wireless network, nor is it limited to a WiMedia standard described as one implementation of the example environment.

Most network standards specify policies or rules that govern the behavior of network connected devices. The WiMedia standard specifies the mechanism and policies that are to be followed by W-USB and WiNet compliant devices in order to allow for an ad hoc and distributed network of such devices to operate efficiently.

In most distributed networks, the network of the devices is maintained by requiring all devices to announce parameters such as their presence, their capabilities and their intentions for reserving transmission slots and so on. For example, with the WiMedia standard, this can be done during what are referred to as beacon period time slots. According to this standard, devices joining the network are expected to monitor the beacon period to learn about the network status and parameters before attempting to use the network. In other network configurations, beacon periods are similarly used to allow management of network devices as described more fully below. Thus, beacon periods are one form of window or network period during which scheduling or other housekeeping activities can be conducted. Beacon periods in the above-referenced standard, and other time periods used for scheduling or other housekeeping chores in other network configurations, are generally referred to as scheduling windows.

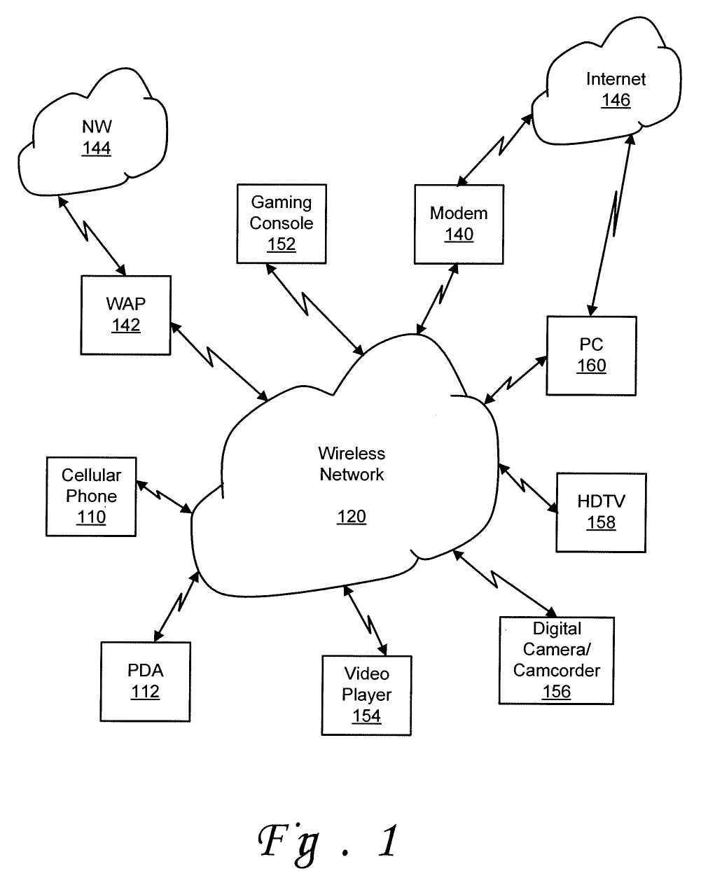

FIG. 1 is a block diagram illustrating one possible configuration of a wireless network that can serve as an example environment in which the present invention can be implemented. Referring now to FIG. 1, a wireless network 120 is provided to allow a plurality of electronic devices to communicate with one another without the need for wires or cables between the devices. A wireless network 120 can vary in coverage area depending on a number of factors or parameters including, for example, the transmit power levels and receive sensitivities of the various electronic devices associated with the network. Examples of wireless networks can include the various IEEE and other standards as described above, as well as other wireless network implementations.

With many applications, the wireless network 120 operates in a relatively confined area, such as, for example, a home or an office. The example illustrated in FIG. 1 is an example of an implementation such as that which may be found in a home or small office environment. Of course wireless communication networks and communication networks in general are found in many environments outside the home and office as well. In the example illustrated in FIG. 1, wireless network 120 includes a communication device to allow it to communicate with external networks. More particularly, in the illustrated example, wireless network 120 includes a modem 140 to provide connectivity to an external network such as the Internet 146, and a wireless access point 142 that can provide external connectivity to another network 144.

Also illustrated in the example wireless network 120 are portable electronic devices such as a cellular telephone 110 and a personal digital assistant (“PDA”) 112. Like the other electronic devices illustrated in FIG. 1, cellular telephone 110 and PDA 112 can communicate with wireless network 120 via the appropriate wireless interface. Additionally, these devices may be configured to further communicate with an external network. For example, cellular telephone 110 is typically configured to communicate with a wide area wireless network by way of a base station.

Additionally, the example environment illustrated in FIG. 1 also includes examples of home entertainment devices connected to wireless network 120. In the illustrated example, electronic devices such as a gaming console 152, a video player 154, a digital camera/camcorder 156, and a high definition television 158 are illustrated as being interconnected via wireless network 120. For example, a digital camera or camcorder 156 can be utilized by a user to capture one or more still picture or motion video images. The captured images can be stored in a local memory or storage device associated with digital camera or camcorder 156 and ultimately communicated to another electronic device via wireless network 120. For example, the user may wish to provide a digital video stream to a high definition television set 158 associated with wireless network 120. As another example, the user may wish to upload one or more images from digital camera 156 to his or her personal computer 160 or to the Internet 146. This can be accomplished by wireless network 120. Of course, wireless network 120 can be utilized to provide data, content, and other information sharing on a peer-to-peer or other basis, as the provided examples serve to illustrate.

Also illustrated is a personal computer 160 or other computing device connected to wireless network 120 via a wireless air interface. As depicted in the illustrated example, personal computer 160 can also provide connectivity to an external network such as the Internet 146.

In the illustrated example, wireless network 120 is implemented so as to provide wireless connectivity to the various electronic devices associated therewith. Wireless network 120 allows these devices to share data, content, and other information with one another across wireless network 120. Typically, in such an environment, the electronic devices would have the appropriate transmitter, receiver, or transceiver to allow communication via the air interface with other devices associated with wireless network 120. These electronic devices may conform to one or more appropriate wireless standards and, in fact, multiple standards may be in play within a given neighborhood. Electronic devices associated with the network typically also have control logic configured to manage communications across the network and to manage the operational functionality of the electronic device. Such control logic can be implemented using hardware, software, or a combination thereof. For example, one or more processors, ASICs, PLAs, and other logic devices or components can be included with the device to implement the desired features and functionality. Additionally, memory or other data and information storage capacity can be included to facilitate operation of the device and communication across the network.

Electronic devices operating as a part of wireless network 120 are sometimes referred to herein as network devices, members or member devices of the network or devices associated with the network. In one embodiment, devices that communicate with a given network may be members or merely in communication with the network.

Some communication networks are divided into periods or frames that can be used for communication and other activities. For example, some networks have a scheduling window such as, for example, a beacon period, for scheduling upcoming communication activities. In addition, some networks have a communication window during which such communication activities take place. In the WiMedia-MBOA standard, the bandwidth is divided into superframes, which in turn are divided into time slots for the transmission and reception of data by the various electronic devices associated with the network.

Some communication networks are divided into periods or frames that can be used for communication and other activities. For example, as discussed above, some networks have a scheduling window such as, for example, a beacon period, for scheduling upcoming communication activities. Also, some networks have a communication window during which communication activities take place. In the WiMedia-MBOA standard, the bandwidth is divided into superframes, which in turn are divided into time slots for the transmission and reception of data by the various electronic devices associated with the network.

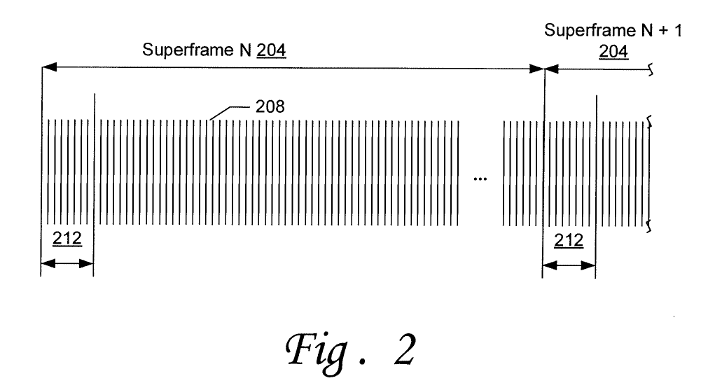

An example of such time slots are illustrated in FIG. 2. Referring now to FIG. 2, in this exemplary environment, the communication bandwidth is divided into superframes 204 (two illustrated), each superframe 204 itself being divided into a plurality of timeslots referred to as Media Access Slots 208. In the example environment, there are 256 media access slots 208 in each superframe 204, although other allocations are possible. Additionally, at the beginning of each superframe 204 is a beacon period 212, which is comprised of a plurality of beaconing slots. In some networks, the beacon period 212 is a period during which devices reserve timeslots and exchange other housekeeping or status information. For example, in the WiMedia-MBOA distributed wireless network, the superframes comprise a beacon period 212, during which devices are awake and receive beacons from other devices.

Superframes in the above-referenced standard, and other time periods used for communications among devices in other network configurations, with or without scheduling windows, are generally referred to herein as communication windows. As noted above, for clarity of description the present invention is described in terms of the example environment, and thus is at times described using the terms superframe and beacon period. As would be apparent to one of ordinary skill in the art after reading this description, the invention applies to other communication formats, including the more general case utilizing scheduling windows and communication windows. Additionally, the invention is not limited to applications where the bandwidth is divided into frames or windows, but can be generally applied to communication channels and networks of various protocols and configurations.

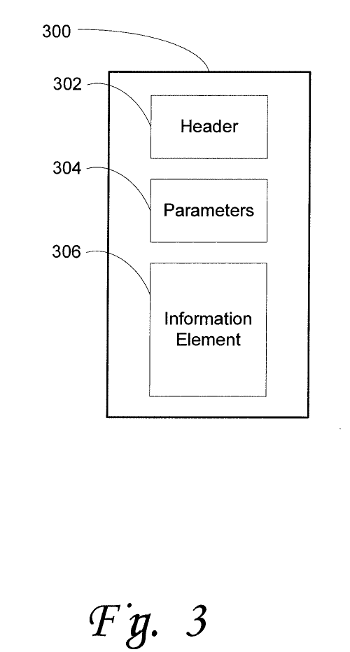

FIG. 3 is a block diagram illustrating an example beacon frame 300. In accordance with one embodiment, beacon frame 300 may be used for transmission during a beacon period. In this way, a wireless device may transmit information elements. In one embodiment, a device might transmit multiple beacon frames during a superframe. The example beacon frame 300 illustrated in FIG. 3 includes a header 302, beacon parameters 304 and Information Element(s) 306. Header 302 may contain routing information for the frame. Beacon parameters 304 can indicate signaling methods in use by the wireless devices. Information element(s) 306 may include just about any information that might normally be included in an Information Element.

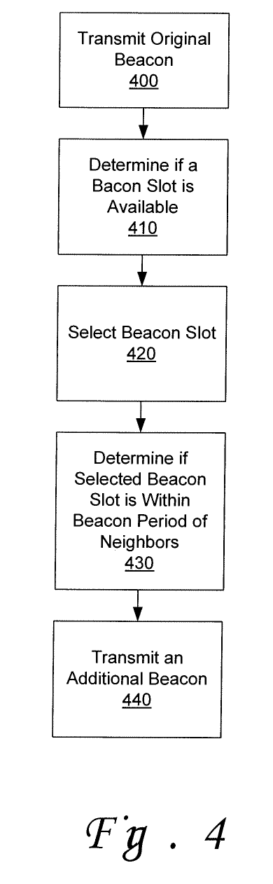

FIG. 4 is a flowchart illustrating an example method for transmitting more data than the maximum length beacon during a beacon period in accordance with the systems and methods described herein is discussed. Referring now to FIG. 4, in a step 400, a beacon may be transmitted. According to the WiMedia Media Access Control Layer specification, a device transmits a beacon during the beacon period of every superframe. The beacon transmitted in step 400 may be referred to as the “original” beacon.

In a step 410, the device determines if a beacon slot is available. Generally, a beacon slot is available when no other device is transmitting during that particular beacon slot. One example embodiment uses the WiMedia communication protocol. Because there is no centralized control in the WiMedia Media Access Control Layer protocol, there is not a Global Beacon Period. A device, therefore, may select its own beacon period, in a step 420. The beacon period may have its own start time and length. The start time and length may, for example, depend on the number of devices within range. In one embodiment, to prevent multiple overlapping beacon periods between devices that are near each other, a device might scan for beacons on a chosen channel for at least one superframe before creating a new beacon period.

In a step 430 a device may determine if a selected beacon slot is within the beacon period of its neighbors. For example, in some cases it might not be necessary for all neighbors to receive a beacon. Accordingly, it may be possible to transmit an extra beacon such that some of the neighboring devices receive it, but not all of them.

In one embodiment, if a beacon is received while scanning, the device may send its beacon in an available beacon slot of the existing beacon period, as illustrated in a step 440. Otherwise, the device may create its own beacon period and send its beacon frame after the initial scan. The WiMedia Media Access Control Layer specification 1.0 defines when a beacon slot is available. For additional details, refer to the WiMedia Media Access Control Layer specification 1.0, incorporated herein by reference.

In some cases an additional beacon or beacons might be transmitted before the original beacon. For example, in some cases an original beacon might be scheduled to occur after some other available beacon period. Because an additional beacons may be transmitted during any other available beacon period this beacon period before the original beacon might be used by the device to send an extra beacon before its scheduled original beacon.

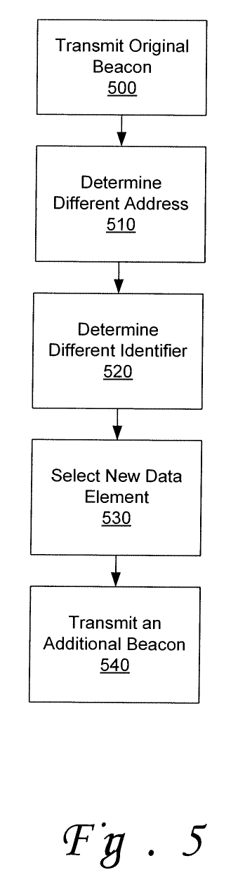

FIG. 5 illustrates another embodiment of a device that might send one or more additional beacons, e.g., in addition to its original beacon during a beacon period. It will be understood by those of skill in the art that, in some embodiments, the features illustrated in FIG. 4 and the features illustrated in FIG. 5 may be combined in one device.

As illustrated in FIG. 5, in a step 500, an original beacon may be transmitted. To allow for transmitting an additional beacon while still being backward compatible with MAC 1.0 devices, in a step 510, the device might use a different device address. The device address might, for example, be the DevAddr of a WiMedia based system. In such an embodiment, the device address may be in the Media Access Control Layer header.

In a step 520, a different identifier might be determined. For example, in one embodiment, using a WiMedia based system, a different 48-bit extended unique identifier might be used. The different 48-bit extended unique identifier might be, for example, in a beacon parameters field. In a step 530, a new data element might be selected. For example, in an embodiment using a WiMedia based system a new Media Access Control Layer information element might be selected from the reserved range of Information Element ID numbers in MAC 1.0 Specification.

In a step 540, an additional beacon may be transmitted. In one embodiment, the additional beacon may be transmitted, for example, during any available beacon slot in the same superframe. The available beacon slot might be before or after the beacon slot for the original beacon. For example, as discussed with respect to FIG. 4, any additional beacon(s) may be sent in any available beacon slots. In some cases a device might transmit an additional beacon only if the chosen beacon slot for its additional beacon is within the beacon period length of all the device's neighbors. In one embodiment, the device includes all information elements it cannot fit in its original beacon in one or more additional beacons.

As discussed above, in some embodiments, a device may use a different device address in the Media Access Control Layer header. Additionally, the device may use a different 48-bit extended unique identifier in the Beacon Parameters field. Current devices that implement MAC 1.0 build tables in their internal space that maps every 48-bit extended unique identifier to a device address that uses its received beacons. If an additional beacon uses the same 48-bit extended unique identifier or the same device address, then depending on how the MAC 1.0 device has been implemented, this might cause a few misbehaviors in constructing the table mentioned above. For example, a MAC 1.0 device may not correctly process multiple beacons from the same device address during the same superframe because this functionality is not defined in the WiMedia MAC 1.0 specification.

Using a different device address and 48-bit extended unique identifier will, in most, if not all cases, have a defined response in a MAC 1.0 device. The device will interpret the beacons as indicating that one or more additional devices are located in the same neighborhood as the MAC 1.0 device. These additional devices are actually a single MAC 2.0 device that is transmitting multiple device address and 48-bit extended unique identifier information. It will be understood that other MAC 1.0 and MAC 2.0 devices may operate in a given area. The MAC 1.0 devices will not be able to differentiate between actual devices and MAC 2.0 devices transmitting alternative device address and 48-bit extended unique identifier information. The MAC 2.0 devices, however, will generally be able to understand these additional beacons.

Using a different device address and 48-bit extended unique identifier might allow a MAC 1.0 device which does not implement the systems and methods described here to function within an environment containing MAC 2.0 devices.

A new Media Access Control Layer Information Element may be created from, for example, the reserved range of Information Element ID numbers in MAC 1.0. The new Information Element may include the original beacon's 48-bit extended unique identifier. This allows a device that implemented the extension proposed in this work, e.g., MAC 2.0, to understand that the information contained in an additional beacon belongs to a device that sent (or will send in the case the additional beacon is sent in an earlier slot) an original beacon in the same superframe. In one embodiment, a new MAC Information Element might include the fields illustrated in table 1, shown below:

TABLE 1
Additional Beacon Indication Information Element format

| octets: 1 | 1 | 6 | L₁ | . . . | Lₖ |
|---|---|---|---|---|---|
| Element | Length | EU148 of the | Information | | Information |
| ID | (=3 × N) | original beacon | Element 1 | | Element k |

In some cases only devices that implement the systems and methods described here, (e.g., MAC 2.0) will be able to understand that the information contained in an additional beacon belongs to a device that sent (or will send) an original beacon in the same superframe. Accordingly, in some embodiments, it is suggested that an additional beacon might only contains new information elements, e.g., information elements not defined in MAC 1.0 and Application Specific information elements targeted to devices that implemented the systems and methods described herein.

In some embodiments, the systems and methods described here might be used in conjunction with a mix of MAC 1.0 and MAC 2.0 neighbors when information elements required 1.0 cannot fit in one beacon payload. In some cases a device may be required to send more information elements than can be accommodated in one beacon. In a current system implementing a WiMedia 1.0 System a designer might decide to alternate between the information elements to avoid exceeding the maximum beacon length. This process might be augmented in a MAC 1.0/2.0 System. For example, using the proposed systems and methods described herein a MAC 2.0 device can include in the additional beacon all information elements that were not included in the original beacon in the same superframe. While such approach will not allow MAC 1.0 device to information any more quickly neighboring devices that are MAC 2.0 since such neighbors will have a more up-to-date version of each others' information elements.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof, the terms “a” or “an” should be read as meaning “at least one,” “one or more,” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a. single package or separately maintained and can further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for a network device to transmit additional beacon data, comprising:
transmitting a first beacon during a predetermined beacon slot in a beacon period of a superframe;
determining if an additional beacon slot is available during the beacon period of the same superframe;
selecting the available beacon slot; and
transmitting a second beacon in the available beacon slot of the same superframe.

2. The method of claim 1, wherein selecting comprises determining if the available beacon slot is within the beacon period of a neighbor of the network device.

3. The method of claim 1, wherein selecting comprises determining if the available beacon slot is within the beacon period of a predetermined set of neighbors of the network device.

4. The method of claim 1, further comprising determining a different device address for the additional beacon.

5. The method of claim 1, further comprising determining a different EUI48 for the additional beacon.

6. The methods of claim 1, wherein the additional beacon includes a new MAC information element.

7. The method of claim 1, wherein the beacon period and the superframe follow the WiMedia standard.

8. A wireless device comprising:
an RF transmitter;
an RF receiver; and
a processor configured to cause the device to:
transmit an first beacon during a predetermined beacon slot in a beacon period of a superframe;
determine if an additional beacon slot is available during the beacon period of the same superframe;
select the available beacon slot; and
transmit a second beacon in the available slot of the same superframe.

9. The wireless device of claim 8, wherein the processor is further configured to determine if the selected beacon slot is within the beacon period of all neighbors.

10. The wireless device of claim 8, wherein the processor is further configured to select a different beacon slot if the originally selected beacon slot is outside of the beacon period of a neighbor.

11. The wireless device of claim 8, wherein the processor is further configured to determine a different device address for the additional beacon.

12. The wireless device of claim 8, wherein the processor is further configured to determine a different EUI48 for the additional beacon.

13. The wireless device of claim 8, wherein the processor is further configured to includes a new MAC information element in the additional beacon.

14. The wireless device of claim 8, wherein the device is configured to operate using a beacon period and a superframe that follow the WiMedia standard.

15. A wireless network comprising:
a first wireless device comprising:
an RF transmitter;
an RF receiver; and
a processor configured to cause the device to:
transmit an first beacon during a predetermined beacon slot in a beacon period of a superframe;
determine if an additional beacon slot is available during the beacon period of the same superframe;
select the available beacon slot; and
transmit a second beacon in the available slot of the same superframe; and
a second wireless device.

16. The wireless network of claim 15, wherein the second device comprises:
an RF transmitter;
an RF receiver; and
a processor configured to cause the device to:
transmit an first beacon during a predetermined beacon slot in a beacon period of a superframe;
determine if an additional beacon slot is available during the beacon period of the same superframe;
select the available beacon slot; and
transmit a second beacon in the available slot of the same superframe.

17. The wireless network of claim 16, wherein the processor in the first wireless device is further configured to determine if the selected beacon slot is within the beacon period of all neighbors.

18. The wireless network of claim 15, wherein the processor in the first wireless device is further configured to select a different beacon slot if the originally selected beacon slot is outside of the beacon period of a neighbor.

19. The wireless network of claim 15, wherein the processor in the first wireless device is further configured to determine a different device address for the additional beacon.

20. The wireless network of claim 15, wherein the processor in the first wireless device is further configured to determine a different EUI48 for the additional beacon.

21. The wireless network of claim 15, wherein the processor in the first wireless device is further configured to includes a new MAC information element in the additional beacon.

23. The wireless network of claim 15, wherein the processor in the first wireless device is further configured to determine if the selected beacon slot is within the beacon period of all neighbors.

24. The wireless network of claim 15, wherein the network is configured to operate using a beacon period and a superframe that follow the WiMedia standard.
